(19) United States
(12) Patent Application Publication
(10) Pub. No.: US 2024/0332594 A1
(43) Pub. Date: Oct. 3, 2024

(54) TRANSPORTATION DEVICE

(71) Applicant: HONDA MOTOR CO., LTD., Tokyo (JP)

(72) Inventor: Yoshiki Muroya, Wako-shi (JP)

(21) Appl. No.: 18/585,103

(22) Filed: Feb. 23, 2024

(30) Foreign Application Priority Data
Mar. 31, 2023 (JP) 2023-058549

(51) Int. Cl. H01M 10/04

(52) U.S. Cl. CPC H01M 10/0468; H01M 10/0404

(57) ABSTRACT

Provided is a transportation device that can perform processing on both long side ends of a laminated element while constantly restraining both ends of the laminated elements over the entire surface, which are not fixed with tape in the lamination direction. A transportation device 1 includes a first restraint member 20 and a second restraint member 30 that restrain a first plate member 11 disposed at one end of an electrode body 200 in a lamination direction and a second plate member 12 disposed at the other end from both sides of the electrode body 200 in the lamination direction, in which the first restraint member 20 includes a first restraint part 21, a second restraint part 22, and a first connection part 23, and the second restraint member 30 includes a third restraint part 31, a fourth restraint part 32, and a second connection part 33.

### BACKGROUND OF THE INVENTION

### Field of the Invention

The present invention relates to a transportation device.

### Description of Related Art

As a method for transporting sheet members laminated in an unstable state, for example, a method including a first process of pressing a horizontal delivery plate against the uppermost layer sheet member and holding it by suction when the pressing device is in a pressed state, a second process of pressing a plurality of sheet members from above in the lamination direction with the base end side of the inclined delivery plate while the pressing device is in a non-pressed state and the delivery plate is in an inclined state after the first process, a third process of inserting a pressing blade into a space created between the uppermost layer sheet member and the lower layer sheet member to put the pressing device in the pressing state again after the second process, and a fourth process of retracting a transfer plate holding the uppermost layer sheet member by suction upward and returning it to a horizontal state, and transferring the uppermost layer sheet member held by the transfer plate by suction to a holder after the third process is known (for example, refer to Patent Document 1).

### PATENT DOCUMENTS

[Patent Document 1] Japanese Unexamined Patent Application, First Publication No. 2020-183312

### SUMMARY OF THE INVENTION

Transportation jigs are required to have common specifications in transportation of a laminated element that is not fixed with tape and in all assembly processes for production line. Specifically, it is necessary to perform processing on both long side end surfaces of the laminated element while constantly restraining both end surfaces of the laminated element in a lamination direction over the entire surface. In Patent Document 1, it is not possible to cope with both the restraint of the laminated element described above and the processing of both long side end surfaces of the laminated element. Moreover, in Patent Document 1, since a laminated element is also fixed with tape, there is no strain resistance against a strong restraining force and there is a possibility of an electrode damage or short circuit.

The present invention provides a transportation device that can perform processing on both long side ends of a laminated element while constantly restraining both ends of a laminated element that is not fixed with tape in a lamination direction over the entire surface. Then, this contributes to energy efficiency.

The present invention has the following aspects.

[1] A transportation device that transports a plurality of electrode bodies includes a first plate member disposed at one end of the electrode body in a lamination direction, a second plate member disposed at the other end, a first restraint member that restrains the first plate member and the second plate member from both sides of the electrode body in the lamination direction, and has a first connection part facing one side surface of the electrode body, and a second restraint member that restrains the first plate member and the second plate member from both sides of the electrode body in the lamination direction, and has a second connection part facing the other side surface of the electrode body, in which the first restraint member includes a first restraint part that is in contact with the first plate member and applies a load to the electrode body, a second restraint part that is in contact with the second plate member and applies a load to the electrode body, and the first connection part that connects the first restraint part and the second restraint part in the lamination direction of the electrode body, and the second restraint member includes a third restraint part that is in contact with the first plate member and applies a load to the electrode body, and a fourth restraint part that is in contact with the second plate member and applies a load to the electrode body, and the second connection part that connects the third restraint part and the fourth restraint part in the lamination direction of the electrode body.

Since the transportation device of the present invention includes the first restraint member that restrains the first plate member disposed at one end of the electrode body in the lamination direction and the second plate member disposed at the other end in the lamination direction from both sides of the electrode body in the lamination direction, and the second restraint member that restrains the first plate member and the second plate member from both sides of the electrode body in the lamination direction, it can perform processing on both long side ends of a laminated element while constantly restraining both ends of the electrode body in the lamination direction over the entire surface, which are not fixed with tape.

[2] In the transportation device described in [1], there is a space between the first connection part and the electrode body while the first plate member and the second plate member are restrained by the first restraint member from both sides of the electrode body in the lamination direction.

The transportation device of the present invention can perform processing on an end of an electrode body while the first plate member and the second plate member are restrained by the first restraint member because there is a space between the first connection part and the electrode body while the plate members are restrained by the first restraint member.

[3] In the transportation device described in [1] or [2], there is a space between the second connection part and the electrode body while the first plate member and the second plate member are restrained by the second restraint member from both sides of the electrode body in the lamination direction.

The transportation device of the present invention can perform processing on an end of an electrode body while the first plate member and the second plate member are restrained by the second restraint member because there is a space between the second connection part and the electrode body while the plate members are restrained by the second restraint member.

[4] In the transportation device described in any one of [1] to [3], the first restraint part and the third restraint part are disposed alternately, and the second restraint part and the fourth restraint part are disposed alternately while the first plate member and the second plate member are restrained by the first restraint member and the second restraint member from both sides of the electrode body in the lamination direction.

The transportation device of the present invention can switch from restraining the electrode body by the first restraint member to restraining the electrode body by the second restraint member without weakening restraint force of the electrode body because the first restraint part and the third restraint part are disposed alternately and the second restraint part and the fourth restraint part are disposed alternately while the first plate member and the second plate member are restrained by the first restraint member and the second restraint member from both sides of the electrode body in the lamination direction.

[5] The transportation device described in any one of [1] to [4] further includes a third restraint member configured to restrain the electrode body, which has been restrained by the first restraint member, from a side opposite to the first connection part, or the electrode body, which has been restrained by the second restraint member, from a side opposite to the second connection part.

The transportation device of the present invention can form an insulating part on the electrode body by including the third restraint member.

According to the present invention, it is possible to provide a transportation device that can perform processing on both long side ends of a laminated element while constantly restraining both ends of the laminated element in the lamination direction over the entire surface, which are not fixed with tape.

### BRIEF DESCRIPTION OF THE DRAWINGS

FIG. 1 is a schematic diagram which shows a transportation device according to an embodiment of the present invention.

FIG. 2 is a schematic diagram which shows a transportation device according to an embodiment of the present invention.

FIG. 3 is a schematic diagram which shows a transportation device according to an embodiment of the present invention.

FIG. 4 is a schematic diagram which shows a transportation device according to an embodiment of the present invention.

FIG. 5 is a schematic diagram which shows a transportation device according to an embodiment of the present invention.

FIG. 6 is a schematic diagram which shows a transportation device according to an embodiment of the present invention.

FIG. 7 is a schematic diagram which shows a transportation device according to an embodiment of the present invention.

FIG. 8 is a schematic diagram which shows a transportation device according to an embodiment of the present invention.

### DETAILED DESCRIPTION OF THE INVENTION

Hereinafter, an embodiment of the present invention will be described in detail with reference to the drawings.

### [Transportation Device]

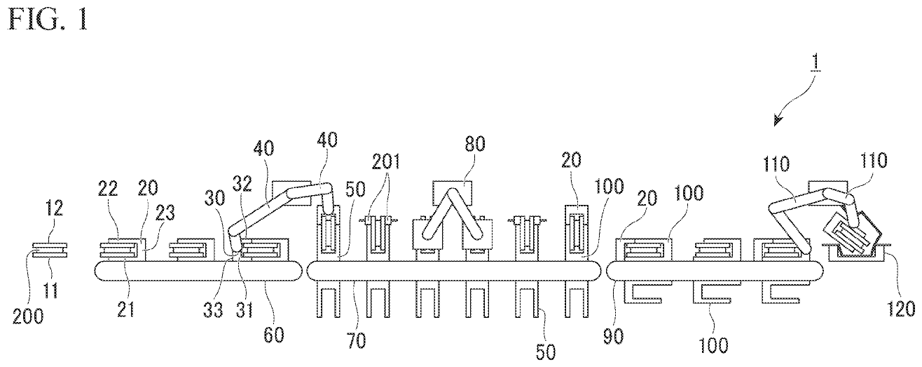

FIGS. 1 to 8 are schematic diagrams which show a transportation device according to an embodiment of the present invention.

As shown in FIG. 1, a transportation device 1 of the present embodiment is a device that transports an electrode body 200. As shown in FIG. 1, the transportation device 1 of the present embodiment includes a first plate member 11, a second plate member 12, a first restraint member 20, and a second restraint member 30.

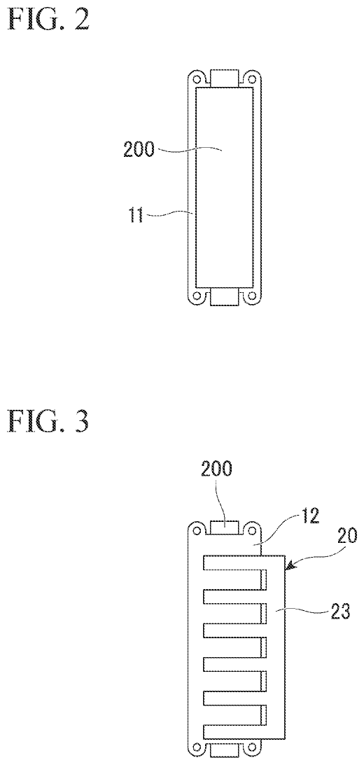

As shown in FIG. 2, the first plate member 11 is disposed at one end of the electrode body 200 in the lamination direction. In addition, as shown in FIG. 3, the second plate member 12 is disposed at the other end of the electrode body 200 in the lamination direction.

As shown in FIGS. 1 and 3, the first restraint member 20 restrains the first plate member 11 and the second plate member 12 from both sides of the electrode body 200 in the lamination direction. The first restraint member 20 has a first restraint part 21, a second restraint part 22, and a first connection part 23.

The first restraint part 21 is in contact with the first plate member 11 and applies a load to the electrode body 200. The second restraint part 22 is in contact with the second plate member 12 and applies a load to the electrode body 200. The first connection part 23 connects the first restraint part 21 and the second restraint part 22 in the lamination direction of the electrode body 200, and faces one side surface of the electrode body 200.

As shown in FIGS. 1 and 3, the second restraint member 30 restrains the first plate member 11 and the second plate member 12 from both sides of the electrode body 200 in the lamination direction. The second restraint member 30 has a third restraint part 31, a fourth restraint part 32, and a second connection part 33. The second restraint member 30 may be connected to a movable arm 40.

The third restraint part 31 is in contact with the first plate member 11 and applies a load to the electrode body 200. The fourth restraint part 32 is in contact with the second plate member 12 and applies a load to the electrode body 200. The second connection part 33 connects the third restraint part 31 and the fourth restraint part 32 in the lamination direction of the electrode body 200, and faces one side surface of the electrode body 200.

As shown in FIG. 1, there is a space between the first connection part 23 and the electrode body 200 while the first plate member 11 and the second plate member 12 are restrained by the first restraint member 20 from both sides of the electrode body 200 in the lamination direction.

As shown in FIG. 1, there is a space between the second connection part 33 and the electrode body 200 while the first plate member 11 and the second plate member 12 are restrained by the second restraint member 30 from both sides of the electrode body 200 in the lamination direction.

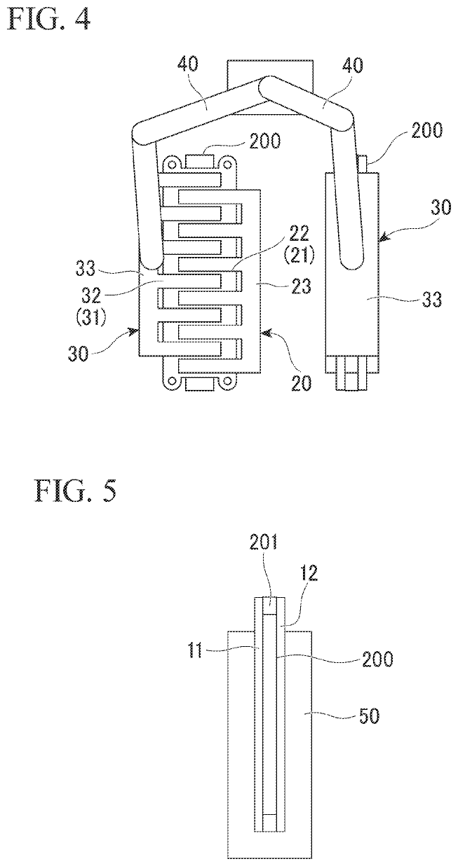

As shown in FIG. 4, the first restraint part 21 and the third restraint part 31 are disposed alternately, and the second restraint part 22 and the fourth restraint part 32 are disposed alternately while the first plate member 11 and the second plate member 12 are restrained by the first restraint member 20 and the second restraint member 30 from both sides of the electrode body 200 in the lamination direction.

As shown in FIG. 1, the transportation device 1 of the present embodiment may also include a third restraint member 50 that restrains the electrode body 200 restrained by the second restraint member 30 from a side opposite to the second connection part 33. Furthermore, the transportation device 1 of the present embodiment may include a third restraint member 50 that restrains the electrode body 200 restrained by the first restraint member 20 from a side opposite to the first connection part 23.

A method of the electrode body 200 using the transportation device 1 of the present embodiment will be described.

As shown in FIGS. 1 and 2, the first plate member 11 is disposed at one end in the lamination direction of a plurality of laminated electrode bodies 200, and a second plate member 12 is disposed at the other end in the lamination direction of the plurality of laminated electrode bodies 200. That is, the first plate member 11 and the second plate member 12 hold (sandwich) the plurality of laminated electrode bodies 200 from both sides in the lamination direction.

Next, as shown in FIGS. 1 and 3, the first plate member 11 and the second plate member 12 holding the plurality of electrode bodies 200 are restrained from both sides of the electrode bodies 200 in the lamination direction by the first restraint member 20. At this time, the first connection part 23 faces one side surface of the electrode body 200. At the same time, the electrode body 200 restrained by the first restraint member 20 is disposed on a belt conveyor 60 so that the first plate member 11 is on the belt conveyor 60 side.

Next, as shown in FIGS. 1 and 4, the electrode body 200 restrained by the first restraint member 20 is restrained from the side opposite to the first connection part 23, and the first plate member 11 and the second plate member 12 holding the plurality of electrode bodies 200 are restrained from both sides of the electrode body 200 in the lamination direction by the second restraint member 30. At this time, the second connection part 33 faces the other side surface of the electrode body 200.

Next, as shown in FIGS. 1 and 4, the electrode body 200 restrained by the second restraint member 30 is raised 90 degrees on the belt conveyor 70 so that a surface direction of the first plate member 11 and the second plate member 12 is orthogonal to a transportation direction of the belt conveyor 70. At the same time, as shown in FIGS. 1 and 5, the third restraint member 50 restrains the electrode body 200 restrained by the second restraint member 30 from the side opposite to the second connection part 33.

Next, as shown in FIGS. 1 and 5, the restraint by the second restraint member 30 is released to expose one end of the electrode body 200 restrained by the third restraint member 50, and an insulating material is applied to the exposed portion to form an insulating part 201 at one end of the electrode body 200, and the electrode body 200 is insulated and sealed.

Next, as shown in FIG. 1, the electrode body 200 with the insulating part 201 formed thereon is turned upside down using the reversing device 80 to expose the other end of the electrode body 200 restrained by the third restraint member 50.

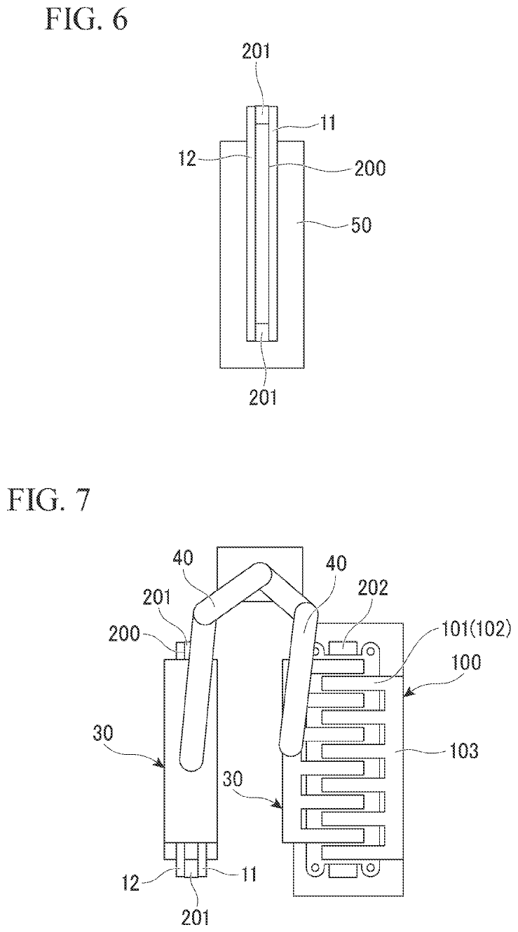

Next, as shown in FIGS. 1 and 6, an insulating material is applied to the exposed portion of the electrode body 200 to form the insulating part 201 at one end of the electrode body 200, and the electrode body 200 is insulated and sealed.

Next, as shown in FIGS. 1 and 7, the electrode body 200, which has been restrained by the third restraint member 50 after the insulating part 201 has been formed, is restrained by the second restraint member 30 from the other end. Thereafter, the electrode body 200 restrained by the second restraint member 30 is removed from the third restraint member 50. The third restraint member 50 from which the electrode body 200 has been removed is collected by the belt conveyor 70 and transported to the previous process.

Next, as shown in FIG. 1, the electrode body 200 restrained by the second restraint member 30 is disposed on the belt conveyor 90 so that the surface direction of the first plate member 11 and the second plate member 12 is along the transportation direction of the belt conveyor 90. At the same time, as shown in FIGS. 1 and 7, the first restraint member 20 restrains the electrode body 200 restrained by the second restraint member 30 from the side opposite to the second connection part 33. Thereafter, electrode tabs 202 are joined to both ends of the electrode body 200.

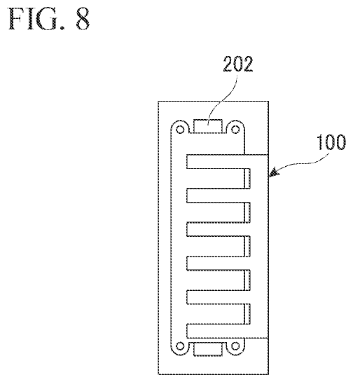

Next, as shown in FIGS. 1 and 8, the fourth restraint member 100 restrains the electrode body 200 restrained by the first restraint member 20 from the side opposite to the second connection part 33.

Next, as shown in FIG. 1, the electrode body 200 is moved to the laminating device 120 using the movable arm 110 connected to the fourth restraint member 100, and the electrode body 200 is laminated and sealed. The fourth restraint member 100 from which the electrode body 200 has been removed is collected by the belt conveyor 90 and transported to the previous process.

Although various embodiments have been described above with reference to the drawings, it goes without saying that the present invention is not limited to such examples. It is clear that various changes and modifications can be made within the scope of the claims and those skilled in the art can understand that these also naturally fall within a technical scope of the present invention. Moreover, each of the component in the embodiments described above may be arbitrarily combined within a range not departing from the gist of the invention.

### EXPLANATION OF REFERENCES

1 Transportation device
11 First plate member
12 Second plate member
20 First restraint member
21 First restraint part
22 Second restraint part
23 First connection part
30 Second restraint member
31 Third restraint part
32 Fourth restraint part
33 Second connection part
40, 110 Movable arm
50 Third restraint member
60, 70, 90 Belt conveyor
80 Reversing device
100 Fourth restraint member
120 Laminating device
200 Electrode body

What is claimed is:

1. A transportation device that transports a plurality of electrode bodies, comprising:
a first plate member disposed at one end of the electrode body in a lamination direction;
a second plate member disposed at the other end;
a first restraint member that restrains the first plate member and the second plate member from both sides of the electrode body in the lamination direction, and has a first connection part facing one side surface of the electrode body; and
a second restraint member that restrains the first plate member and the second plate member from both sides of the electrode body in the lamination direction, and has a second connection part facing the other side surface of the electrode body,
wherein the first restraint member includes a first restraint part that is in contact with the first plate member and applies a load to the electrode body, a second restraint part that is in contact with the second plate member and applies a load to the electrode body, and the first connection part that connects the first restraint part and the second restraint part in the lamination direction of the electrode body, and
the second restraint member includes a third restraint part that is in contact with the first plate member and applies a load to the electrode body, and a fourth restraint part that is in contact with the second plate member and applies a load to the electrode body, and the second connection part that connects the third restraint part and the fourth restraint part in the lamination direction of the electrode body.

2. The transportation device according to claim 1,
wherein there is a space between the first connection part and the electrode body while the first plate member and the second plate member are restrained by the first restraint member from both sides of the electrode body in the lamination direction.

3. The transportation device according to claim 1,
wherein there is a space between the second connection part and the electrode body while the first plate member and the second plate member are restrained by the second restraint member from both sides of the electrode body in the lamination direction.

4. The transportation device according to claim 1,
wherein the first restraint part and the third restraint part are disposed alternately, and the second restraint part and the fourth restraint part are disposed alternately while the first plate member and the second plate member are restrained by the first restraint member and the second restraint member from both sides of the electrode body in the lamination direction.

5. The transportation device according to claim 1, further comprising:
a third restraint member configured to restrain the electrode body, which has been restrained by the first restraint member, from a side opposite to the first connection part, or the electrode body, which has been restrained by the second restraint member, from a side opposite to the second connection part.
